(19) United States
(12) Patent Application Publication
(10) Pub. No.: US 2026/0255287 A1
(43) Pub. Date: Aug. 27, 2026

(54) COMMUNICATION METHOD AND APPARATUS

(71) Applicant: HUAWEI TECHNOLOGIES CO., LTD., Shenzhen (CN)

(72) Inventors: Hailong HOU, Beijing (CN); Zhiheng GUO, Beijing (CN)

(73) Assignee: HUAWEI TECHNOLOGIES CO., LTD., Shenzhen (CN)

(21) Appl. No.: 19/535,971

(22) Filed: Feb. 10, 2026

Related U.S. Application Data
(63) Continuation of application No. PCT/CN2024/110876, filed on Aug. 9, 2024.

(30) Foreign Application Priority Data
Aug. 10, 2023 (CN) 202311010367.7

(51) Int. Cl. H04W 56/00; H04W 74/0833

(52) U.S. Cl. CPC H04W 56/001; H04W 74/0833

(57) ABSTRACT

A terminal device may receive, based on at least two candidate frequency positions of M candidate frequency positions, at least two SSBs in a synchronization burst set from a network device. In other words, different SSBs in the synchronization burst set are sent in a frequency division manner. In this way, time taken by the terminal device for SSB search can be reduced, so that the terminal device can perform synchronization based on a found SSB more quickly and initiate random access, and therefore, an access delay can be reduced. In addition, as the network device sends different SSBs in the synchronization burst set in the frequency division manner, the network device may complete sending the SSBs in the synchronization burst set in shorter time.

### CROSS-REFERENCE TO RELATED APPLICATIONS

This application is a continuation of International Application No. PCT/CN2024/110876, filed on Aug. 9, 2024, which claims priority to Chinese Patent Application No. 202311010367.7, filed on Aug. 10, 2023. The disclosures of the aforementioned applications are hereby incorporated by reference in their entireties.

### TECHNICAL FIELD

The embodiments relate to the field of communication technologies, a communication method, and an apparatus.

### BACKGROUND

To improve synchronization signal block (SSB) coverage performance, a beam sweeping mechanism is introduced into new radio (NR) to perform SSB transmission. In other words, a network device may repeatedly perform SSB transmission in different directions through different beams. For a beam direction, as energy is more concentrated, an SSB receive power may be higher for a terminal device, so that the SSB coverage performance is improved. For the foregoing beam-based SSB transmission process, time division multiplexing is performed between different SSB beams, the network device sends SSBs at different time through different beams. This means that the terminal device also needs to perform SSB search at different time through different beams to obtain an appropriate SSB through detection. In this way, the terminal device can perform synchronization based on the SSB, to initiate random access. However, time consumed in a process of performing SSB search at different time through different beams to obtain the appropriate SSB through detection is long. Consequently, an access delay of the terminal device is long.

### SUMMARY

The embodiments provide a communication method and apparatus, to reduce time taken by a terminal device for SSB search, so that the terminal device can perform synchronization based on a found SSB more quickly and initiate random access, and therefore, an access delay of the terminal device can be reduced.

According to a first aspect, a communication method is provided. The method may be performed by a terminal device, or may be performed by a module (for example, a processor, a chip, or a chip system) used in the terminal device, or may be implemented by a logical node, a logical module, or software that can implement all or some functions of the terminal device. In the communication method, M candidate frequency positions are determined, where one of the M candidate frequency positions is used to transmit one synchronization signal block SSB in a synchronization burst set, the synchronization burst set includes N SSBs, and both M and N are integers greater than or equal to 2. In this case, at least two SSBs of the N SSBs from a network device can be received based on at least two candidate frequency positions of the M candidate frequency positions, and the at least two SSBs are associated with different index values.

In the foregoing embodiment, the terminal device may receive, based on the at least two candidate frequency positions of the M candidate frequency positions, the at least two SSBs in the synchronization burst set from the network device. In other words, different SSBs (a plurality of SSBs may be associated with different index values, indicating different SSBs) in the synchronization burst set are sent in a frequency division manner. In this way, time taken by the terminal device for SSB search can be reduced, so that the terminal device can perform synchronization based on a found SSB more quickly and initiate random access, and therefore, an access delay can be reduced. In addition, as the network device sends different SSBs in the synchronization burst set in the frequency division manner, the network device may complete sending the SSBs in the synchronization burst set in shorter time. In this way, the network device can be shut down in shorter time as required, so that energy consumption of the network device can be reduced, thereby facilitating energy saving of the network device.

With reference to the first aspect, optionally, that the at least two SSBs of the N SSBs from the network device are received based on the at least two candidate frequency positions of the M candidate frequency positions includes: receiving, based on the at least two candidate frequency positions and at least two candidate time-domain positions, the at least two SSBs from the network device.

In the foregoing embodiment, the terminal device may receive, based on the at least two candidate frequency positions and the at least two candidate time-domain positions, the at least two SSBs from the network device. In other words, different SSBs in the synchronization burst set are sent in the frequency division manner and a time division manner. In this way, in a scenario in which a carrier bandwidth is limited (a quantity of frequency division-based SSBs is limited in this scenario), a cell is enabled to support more SSBs, thereby improving SSB coverage performance.

According to a second aspect, a communication method is provided. The method may be performed by a network device, or may be performed by a module (for example, a processor, a chip, or a chip system) used in the network device, or may be implemented by a logical node, a logical module, or software that can implement all or some functions of the network device. In the communication method, M candidate frequency positions are determined, where one of the M candidate frequency positions is used to transmit one synchronization signal block SSB in a synchronization burst set, the synchronization burst set includes N SSBs, and both M and N are integers greater than or equal to 2. In this case, in at least two candidate frequency positions of the M candidate frequency positions, at least two SSBs of the N SSBs can be sent to a terminal device, and the at least two SSBs are associated with different index values.

In the foregoing embodiment, the network device may send, in the at least two candidate frequency positions of the M candidate frequency positions, the at least two SSBs in the synchronization burst set to the terminal device. In other words, different SSBs in the synchronization burst set are sent in a frequency division manner. In this way, time taken by the terminal device for SSB search can be reduced, so that the terminal device can perform synchronization based on a found SSB more quickly and initiate random access, and therefore, an access delay can be reduced. In addition, as the network device sends different SSBs in the synchronization burst set in the frequency division manner, the network device may complete sending the SSBs in the synchronization burst set in shorter time. In this way, the network device can be shut down in shorter time as required, so that energy consumption of the network device can be reduced, thereby facilitating energy saving of the network device.

With reference to the second aspect, optionally, sending the at least two candidate frequency positions of the M candidate frequency positions and the at least two SSBs of the N SSBs to the terminal device may further include: sending, in the at least two candidate frequency positions and at least two candidate time-domain positions, the at least two SSBs to the terminal device.

In the foregoing embodiment, the network device may send, in the at least two candidate frequency positions and the at least two candidate time-domain positions, the at least two SSBs to the terminal device. In other words, different SSBs in the synchronization burst set are sent in the frequency division manner and a time division manner. In this way, in a scenario in which a carrier bandwidth is limited (a quantity of frequency division-based SSBs is limited in this scenario), a cell is enabled to support more SSBs, thereby improving SSB coverage performance.

With reference to the first aspect or the second aspect, optionally, the M candidate frequency positions are associated with M synchronization raster (synchronization raster) positions, or the M candidate frequency positions are associated with one synchronization raster position.

With reference to the first aspect or the second aspect, optionally, that the M candidate frequency positions are associated with one synchronization raster position includes: A first candidate frequency position of the M candidate frequency positions is associated with one synchronization raster position, and M-1 candidate frequency positions of the M candidate frequency positions other than the first candidate frequency position are determined based on the first candidate frequency position and/or frequency spacing between adjacent candidate frequency positions of the M candidate frequency positions. The frequency spacing between adjacent candidate frequency positions of the M candidate frequency positions is predefined, or the frequency spacing between adjacent candidate frequency positions of the M candidate frequency positions is indicated by the network device to the terminal device.

With reference to the first aspect or the second aspect, optionally, when M is an odd number, the first candidate frequency position is an [(M+1)/2]^{th} candidate frequency position of the M candidate frequency positions; and/or when M is an even number, the first candidate frequency position is an (M/2)^{th} candidate frequency position or an (M/2+1)^{th} candidate frequency position of the M candidate frequency positions. An intermediate SSB of a plurality of SSBs that can be multiplexed in the frequency division manner can be enabled to be located at a predefined frequency position, to help the terminal device adjust an operating frequency range of a radio frequency link of the terminal device when SSB search and detection are performed, thereby reducing complexity of the terminal device.

With reference to the first aspect or the second aspect, optionally, a resource element (resource element, RE) of an SSB in the synchronization burst set is located at one of the M candidate frequency positions, and the RE is a central RE of the SSB in the synchronization burst set, a 1^{st} RE of the SSB in the synchronization burst set, or a last RE of the SSB in the synchronization burst set.

With reference to the first aspect or the second aspect, optionally, a maximum quantity of frequency division-based SSBs in the synchronization burst set is determined based on a frequency range to which the M candidate frequency positions belong.

With reference to the first aspect or the second aspect, optionally, the M candidate frequency positions belong to a first set, and a candidate frequency position in the first set satisfies the following formula: F1+L1*First frequency spacing+K1*Second frequency spacing, where F1 is a reference frequency position of a frequency range to which the candidate frequency positions in the first set belong, L1 is an integer greater than or equal to 0, K1 is an integer greater than or equal to 0, and the first frequency spacing is different from the second frequency spacing.

With reference to the first aspect or the second aspect, optionally, a size of the first frequency spacing is greater than a bandwidth of an SSB in the synchronization burst set, and/or a size of the second frequency spacing is greater than or equal to a bandwidth of an SSB in the synchronization burst set.

With reference to the first aspect or the second aspect, optionally, the M candidate frequency positions belong to a second set, and a candidate frequency position in the second set satisfies the following formula: F2+L2*Third frequency spacing, where F2 is a reference frequency position of a frequency range to which the candidate frequency positions in the second set belong, and L2 is an integer greater than or equal to 0.

With reference to the first aspect or the second aspect, optionally, a size of the third frequency spacing is greater than or equal to a bandwidth of an SSB in the synchronization burst set.

With reference to the first aspect or the second aspect, optionally, the SSBs in the synchronization burst set are consecutively mapped to a pattern of candidate time-frequency positions of the SSBs in the synchronization burst set firstly in ascending order of indexes of frequency-domain units and then in ascending order of indexes of time units; or the SSBs in the synchronization burst set are consecutively mapped to a pattern of candidate time-frequency positions of the SSBs in the synchronization burst set firstly in ascending order of indexes of time units and then in ascending order of indexes of frequency-domain units. The pattern of the candidate time-frequency positions of the SSBs in the synchronization burst set is predefined or preconfigured, or the pattern of the candidate time-frequency positions of the SSBs in the synchronization burst set is indicated by the network device to the terminal device.

With reference to the first aspect or the second aspect, optionally, a period of an SSB in the synchronization burst set is the same as or different from a period of the synchronization burst set.

With reference to the first aspect or the second aspect, optionally, the period of the SSB in the synchronization burst set is the same as the period of the synchronization burst set, and both the period of the SSB in the synchronization burst set and the period of the synchronization burst set are less than 5 milliseconds.

With reference to the first aspect or the second aspect, optionally, the period of the SSB in the synchronization burst set is different from the period of the synchronization burst set, the period of the synchronization burst set is greater than or equal to 5 milliseconds, and the period of the SSB in the synchronization burst set is less than 5 milliseconds.

According to a third aspect, a communication apparatus is provided, and includes units or modules configured to implement the method according to either the first aspect or the second aspect.

According to a fourth aspect, a communication apparatus is provided, where the communication apparatus includes at least one processor and a memory. The memory is configured to store a computer program or instructions, and the at least one processor is configured to execute the computer program or the instructions in the memory, to perform the method according to either the first aspect or the second aspect.

According to a fifth aspect, a communication system is provided, where the communication system includes a terminal device and a network device. The terminal device is configured to perform the method according to the first aspect, and the network device is configured to perform the method according to the second aspect.

According to a sixth aspect, a non-transitory computer-readable storage medium is provided, where the non-transitory computer-readable storage medium stores computer instructions. When the computer instructions are executed, a computer is enabled to perform the method according to either the first aspect or the second aspect.

According to a seventh aspect, a computer program product is provided, where the computer program product includes computer program code. When the computer program code is run by a computer, the computer is enabled to perform the method according to either the first aspect or the second aspect.

According to an eighth aspect, a chip is provided, where the chip includes at least one processor and an interface. The processor is configured to read and execute instructions stored in a memory. When the instructions are run, the chip is enabled to perform the method according to either the first aspect or the second aspect.

### BRIEF DESCRIPTION OF DRAWINGS

The following briefly describes accompanying drawings used for describing embodiments.

FIG. 1 shows a basic architecture of a communication system according to an embodiment;

FIG. 2 is a diagram of a time-frequency resource occupied by an SSB;

FIG. 3 is a schematic flowchart of a communication method according to an embodiment;

FIG. 4 is a diagram of determining a candidate frequency position according to an embodiment;

FIG. 5 is another diagram of determining a candidate frequency position according to an embodiment;

FIG. 6 is a diagram of patterns of candidate frequency positions of SSBs according to an embodiment;

FIG. 7 is a diagram of selecting candidate frequency positions of SSBs according to an embodiment;

FIG. 8 is a diagram of a structure of a communication apparatus according to an embodiment; and

FIG. 9 is a diagram of a structure of another communication apparatus according to an embodiment.

### DETAILED DESCRIPTION OF EMBODIMENTS

The following describes the embodiments with reference to the accompanying drawings. The terms “system” and “network” may be used interchangeably in the embodiments. Unless otherwise specified, “/” represents an “or” relationship between associated objects. For example, A/B may represent A or B. The term “and/or” is merely an association relationship for describing associated objects, and represents that three relationships may exist. For example, A and/or B may represent the following three cases: only A exists, both A and B exist, and only B exists, where A and B each may be singular or plural. In addition, in the descriptions, “a plurality of” means two or more than two unless otherwise specified. “At least one of the following items (pieces)” or a similar expression thereof means any combination of these items, including a singular item (piece) or any combination of plural items (pieces). For example, at least one of a, b, or c may indicate: a, b, c, a and b, a and c, b and c, or a, b, and c, where a, b, and c may be singular or plural. In addition, to clearly describe the embodiments, terms such as “first” and “second” are used to distinguish between same items or similar items that provide basically same network elements and purposes. A person skilled in the art may understand that the terms such as “first” and “second” do not limit a quantity or an execution sequence, and the terms such as “first” and “second” do not indicate a definite difference.

Reference to “an embodiment”, “some embodiments”, or the like described in the embodiments means that one or more embodiments include a specific feature, structure, or characteristic described with reference to the embodiments. Therefore, statements such as “in an embodiment,” “in some embodiments,” “in some other embodiments,” and “in other embodiments” do not necessarily mean referring to a same embodiment. Instead, the statements mean “one or more but not all of embodiments,” unless otherwise specifically emphasized in another manner. The terms “include,” “have,” and their variants all mean “include, but are not limited to”, unless otherwise specifically emphasized in another manner.

The embodiments are further described in detail in the following implementations. The following descriptions are merely specific implementations of the embodiments, but are not intended as limiting. Any modification, equivalent replacement, improvement, or the like made based on the embodiments shall fall within the scope of the embodiments.

In the various embodiments, unless otherwise stated or there is a logic conflict, terms and/or descriptions in the different embodiments are consistent and may be mutually referenced, and the different embodiments may be combined based on an internal logical relationship thereof, to form a new embodiment.

The embodiments may be applied to a long term evolution (LTE) architecture, a 5^{th} generation mobile communication technology (5G), a wireless local area network (WLAN) system, a vehicle-to-everything (V2X) communication system, LTE-vehicle (LTE-V), vehicle-to-vehicle (V2V), Internet of vehicles, machine type communication (MTC), and the like. The embodiments may be further applied to another future communication system, for example, a 6G communication system. In a future communication system, a same function may be maintained, but a name may be changed. In addition, the embodiments may be further applied to a non-terrestrial network (NTN) or a scenario in which an NTN and a terrestrial network (TN) are integrated.

The following describes a basic architecture of a communication system provided in the embodiments. The communication system may include one or more network devices and one or more terminal devices.

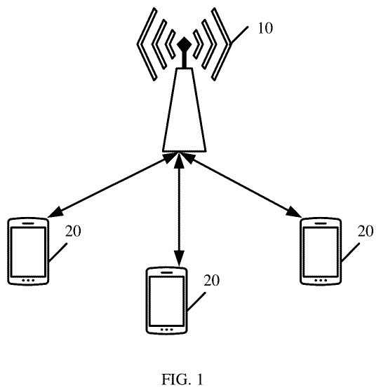

The following uses a system architecture shown in FIG. 1 as an example for description. As shown in FIG. 1, the communication system includes a network device 10 and one or more terminal devices (for example, a terminal device 20 in FIG. 1) communicating with the network device 10.

Quantities of network devices and terminal devices in FIG. 1 are merely examples. The following describes in detail the terminal device and the network device that are related to the system architecture.

### 1. Terminal device

A terminal device is an entity on a user side configured to receive a signal, or send a signal, or receive a signal and send a signal. The terminal device is configured to provide one or more of a voice service and a data connectivity service for a user. The terminal device may be a device that has a wireless transceiver function and that may cooperate with a network device to provide a communication service for the user.

The terminal device may be user equipment (UE), an access terminal, a subscriber unit, a subscriber station, a mobile station, a remote station, a remote terminal, a mobile device, a terminal, a wireless communication device, a user agent, a user apparatus, or a road side unit (RSU). The terminal device may alternatively be an unmanned aerial vehicle, an Internet of things (IoT) device, a station (station, ST) in a wireless local area network (WLAN), a cellular phone, a smartphone, a cordless phone, a wireless data card, a tablet computer, a session initiation protocol (SIP) phone, a wireless local loop (WLL) station, a personal digital assistant (PDA) device, a laptop computer, a machine type communication (MTC) terminal, a handheld device with a wireless communication function, a compute device or another processing device connected to a wireless modem, a vehicle-mounted device, a wearable device (also referred to as a wearable smart device), a virtual reality (VR) terminal, an augmented reality (AR) terminal, a wireless terminal in telemedicine (remote medical), a wireless terminal in industrial control, a wireless terminal in self driving, a wireless terminal in a smart grid, a wireless terminal in transportation safety, a wireless terminal in a smart city, a wireless terminal in a smart home, or the like. The terminal device may alternatively be a terminal in a 5G system, or a terminal in a next-generation communication system. This is not limited.

In the embodiments, a device form of the terminal device is not limited. An apparatus configured to implement a function of the terminal device may be a terminal device, or may be an apparatus, for example, a chip system, that can support the terminal device in implementing the function. The apparatus may be mounted in a terminal device or used in a manner of matching a terminal device. In the embodiments, the chip system may include a chip, or may include a chip and another discrete component.

### 2. Network device

A network device is an entity on a network side configured to send a signal, or receive a signal, or send a signal and receive a signal. The network device may be an apparatus deployed in a radio access network (RAN) to provide a wireless communication function for the terminal device.

In a possible scenario, the network device may be a device having a base station function, for example, an evolved NodeB (eNodeB), a transmission reception point (TRP), a transmission point (TP), a next generation NodeB (gNB), a next generation base station in a 6G mobile communication system, an integrated access and backhaul (IAB) node, or a non-terrestrial network device in an NTN, a device or a satellite that can be deployed on a high-altitude platform, or the like. The network device may be a transmission reception point (TRP), a base station, or a control node in various forms, for example, a network controller, a radio controller, or the like.

The network device may be a macro base station in various forms, a micro base station (also referred to as a small cell) in a heterogeneous network (HetNet) scenario, a relay station, an access point (AP), a radio network controller (RNC), a NodeB (NB), a base station controller (BSC), a base transceiver station (BTS), a home base station (HNB), a baseband unit (BBU) and a radio unit (RRU) in a distributed base station scenario, a transmission point (TRP), a transmission point (TP), a mobile switching center, or the like, or may be an antenna panel of a base station. The control node may be connected to a plurality of base stations, and configure resources for a plurality of terminals covered by the plurality of base stations. In systems using different radio access technologies, names of devices having a function of a base station may vary. For example, the device may be a gNB in 5G, a network side device in a network after 5G, a network device in a future evolved public land mobile (communication) network (PLMN) network, or a device having a base station function in device-to-device (D2D) communication, machine-to-machine (M2M) communication, or Internet of vehicles communication. A specific name of the network device is not limited. Alternatively, the network device may be an open access network (ORAN), a baseband pool (BBU pool) and an RRU in a cloud radio access network (CRAN), or the like.

All or some functions of the network device may alternatively be implemented through a software function running on hardware, or implemented through a virtualized function instantiated on a platform (for example, a cloud platform). The network device may alternatively be a logical node, a logical module, or software that can implement all or some functions of the network device.

In another possible scenario, a plurality of network devices may collaborate to assist the terminal device in implementing wireless access, and different network devices separately implement some functions of the base station. For example, the network device may include a central unit (CU), a distributed unit (DU), a CU-control plane (CP), a CU-user plane (UP), a radio unit (RU), or the like. The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). The network device may be a CU node, a DU node, or a device including a CU node and a DU node. In addition, the CU may be classified as a network device in an access network RAN, or the CU may be classified as a network device in a core network CN. This is not limited herein.

In different systems, the CU (or the CU-CP and the CU-UP), the DU, or the RU may also have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples. Any one of the CU (or the CU-CP or the CU-UP), the DU, and the RU may be implemented by using a software module, a hardware module, or a combination of the software module and the hardware module.

A form of the network device is not limited. An apparatus configured to implement a function of the network device may be a network device, or may be an apparatus, for example, a chip system, that can support the network device in implementing the function. The apparatus may be mounted in the network device or used in a manner of matching the network device.

To facilitate understanding, the following further explains and describes some terms in the embodiments, so as to facilitate understanding by a person skilled in the art. This ease of understanding.

### 1. SSB

An SSB may be used for time-frequency synchronization between a terminal device and a network device, to obtain broadcast information, and the like. The broadcast information includes a master information block (MIB) from a higher layer and timing-related information from a physical layer. The SSB may be further used for at least one of channel quality measurement, radio resource management (RRM) measurement, radio link monitor (RLM), and the like. The SSB may also be referred to as a physical broadcast channel (PBCH) block, and includes a primary synchronization signal (PSS), a secondary synchronization signal (SSS), and a PBCH. The terminal device performs time-frequency synchronization with the network device through the PSS and the SSS, to obtain a physical layer cell identifier (PCI) and the like. The PBCH may carry the broadcast information.

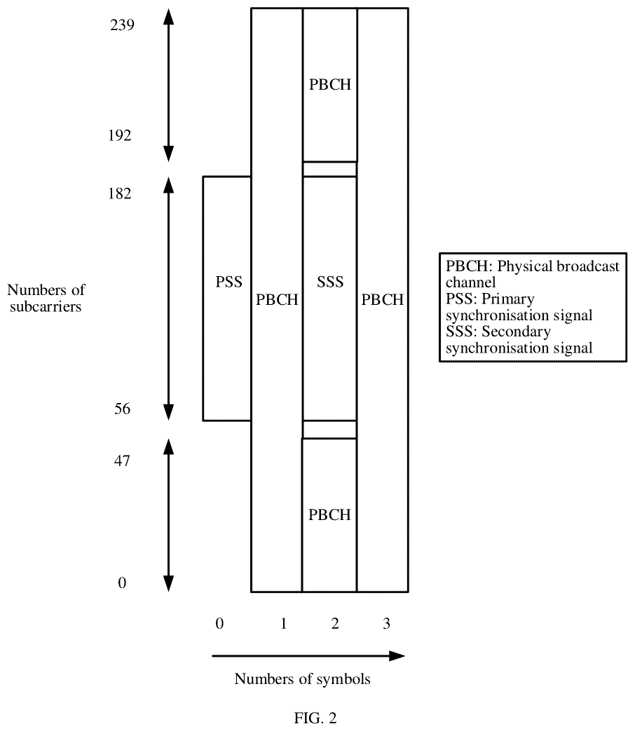

In time domain, one SSB occupies four symbols: a symbol 0 to a symbol 3. In frequency domain, one SSB occupies 20 resource blocks (RB) (one RB includes 12 subcarriers), 240 subcarriers, and numbers of the subcarriers are 0 to 239. For example, as shown in FIG. 2, the PSS is located on intermediate 127 subcarriers of the symbol 0, and the SSS is located on intermediate 127 subcarriers of the symbol 2. To protect the PSS and the SSS, there are respective different guard subcarriers. The guard subcarrier is not used to carry a signal. Subcarriers are separately reserved on two sides of the SSS as guard subcarriers. For example, blank areas on the two sides of the SSS in FIG. 2 are the guard subcarriers. The PBCH occupies all subcarriers of the symbol 1 and the symbol 3, and occupies some subcarriers of remaining subcarriers other than the subcarriers occupied by the SSS in all subcarriers of the symbol 2 (subcarriers other than the guard subcarriers in the remaining subcarriers).

Symbols may be orthogonal frequency-division multiplexing (OFDM) symbols. For ease of description, the OFDM symbol is briefly referred to as a symbol below.

The SSB may be classified into a cell-defining SSB (CD-SSB) and a non-cell-defining SSB (non-CD-SSB). The CD-SSB may be used for cell search and access. The CD-SSB may be associated with a system information block 1 (SIB 1). For example, after receiving the CD-SSB, the terminal device may further receive the SIB 1 associated with the CD-SSB, to perform cell camping, access, and the like. The non-CD-SSB may be used for measurement.

### 2. RE

An RE may be a subcarrier on a symbol, and the RE is a minimum physical unit in an NR standard.

### 3. Time Unit

A time unit may be, for example, a symbol. An index of the time unit may be used to uniquely identify the time unit. The index of the time unit may have another name, for example, an identifier of the time unit or a number of the time unit. This is not limited.

### 4. Frequency-Domain Unit

A frequency-domain unit may be, for example, a subcarrier. An index of the frequency-domain unit may be used to uniquely identify the frequency-domain unit. The index of the frequency-domain unit may have another name, for example, an identifier of the frequency-domain unit or a number of the frequency-domain unit. This is not limited.

### 5. Synchronization Burst Set (SS Burst Set)

A set of SSBs sent by a network device in one beam sweeping process may be referred to as a synchronization burst set. The synchronization burst set may include one or more SSBs. Index values (index) associated with different SSBs in the synchronization burst set are different. Bandwidths of all SSBs in the synchronization burst set are the same. Optionally, a bandwidth of an SSB in the synchronization burst set is related to a quantity of RBs occupied by the SSB, a quantity of subcarriers included in the RB, and subcarrier spacing. In other words, the bandwidth of the SSB in the synchronization burst set is determined based on the quantity of RBs occupied by the SSB, the quantity of subcarriers included in the RB, and the subcarrier spacing. For example, the SSB occupies 20 RBs, the RB includes 12 subcarriers, and the subcarrier spacing is 15 kilohertz (kHz). In this case, the bandwidth of the SSB is 15 kHz*12*20=3.6 MHz. “*” indicates multiplication.

Generally, the network device may send the SSBs in the synchronization burst set in a time division manner. In this way, the terminal device needs to spend a long time in searching for SSBs and obtaining an appropriate SSB through detection. Consequently, an access delay of the terminal device may be long. In addition, for the network device, when the SSBs are sent in different beam directions in a time division multiplexing manner, the network device needs to keep in an operating state for longer time, and consumes more energy. Consequently, it is not conducive to energy saving of the network device. In view of this, the embodiments may provide a communication method to resolve these problems.

The following describes the embodiments in detail. For example, the terminal device in the following may be the terminal device in FIG. 1, and the network device in the following may be the network device in FIG. 1. Names of messages between network elements, names of parameters in the messages, or the like in the following embodiments are merely examples, and there may be other names in a specific implementation. This is not limited.

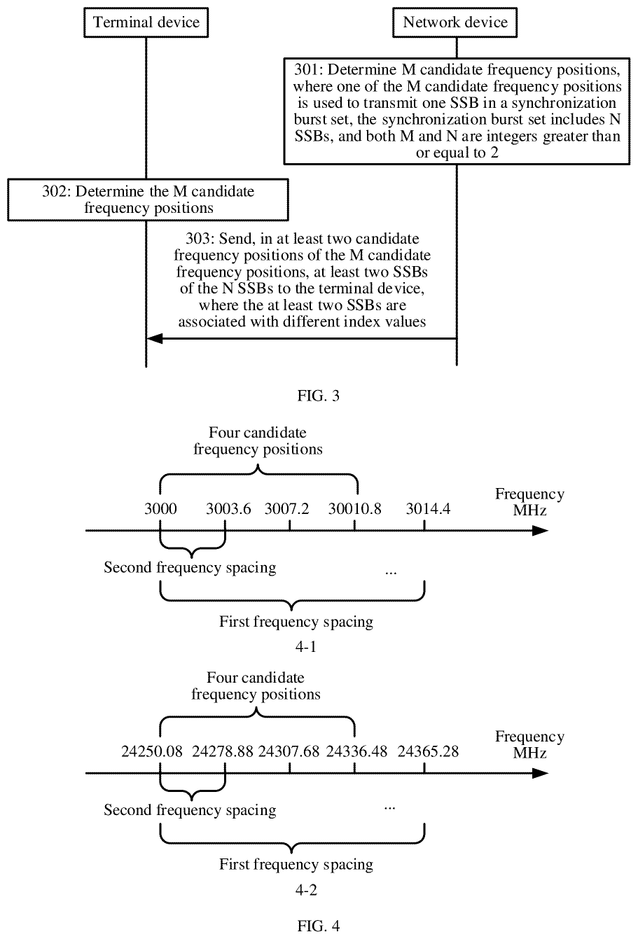

FIG. 3 shows a communication method according to an embodiment. The communication method includes, but is not limited to, the following steps (or operations).

301: A network device determines M candidate frequency positions, where one of the M candidate frequency positions is used to transmit one SSB in a synchronization burst set, the synchronization burst set includes N SSBs, and both M and N are integers greater than or equal to 2.

302: A terminal device determines the M candidate frequency positions.

For the M candidate frequency positions in step 302, refer to related descriptions in step 301. Details are not described herein again.

303: The network device sends, in at least two candidate frequency positions of the M candidate frequency positions, at least two SSBs of the N SSBs to the terminal device, where the at least two SSBs are associated with different index values.

Correspondingly, the terminal device receives the at least two SSBs from the network device based on the at least two candidate frequency positions.

The following describes implementations of step 301 to step 303.

There is an association relationship between the M candidate frequency positions and synchronization raster positions. Details are as follows.

I. The M candidate frequency positions are associated with M synchronization raster positions.

Optionally, the M candidate frequency positions are in one-to-one correspondence with the M synchronization raster positions. The one-to-one correspondence (the one-to-one correspondence between the M candidate frequency positions and the M synchronization raster positions) may be predefined or preconfigured. Synchronization rasters may define candidate frequency positions of SSBs. Predefined may refer to being predefined in a protocol, and preconfigured may refer to information recorded in hardware and/or software in the terminal device or the network device.

II. The M candidate frequency positions are associated with one synchronization raster position.

Optionally, the network device or the terminal device may determine the M candidate frequency positions in either of the following manners. Details are as follows.

1. The M candidate frequency positions may belong to a first set or a second set. For example, when the M candidate frequency positions are associated with one synchronization raster position, the M candidate frequency positions may belong to the first set or the second set. In other words, when the M candidate frequency positions are associated with the one synchronization raster position, the M candidate frequency positions may be determined through the first set or the second set. A quantity of candidate frequency positions included in the first set or the second set may be greater than or equal to M. When the quantity of candidate frequency positions included in the first set or the second set is greater than M, the M candidate frequency positions may be first M candidate frequency positions, last M candidate frequency positions, or any M candidate frequency positions in the first set or the second set, which is not limited herein.

Optionally, a candidate frequency position in the first set satisfies the following formula: F1+L1*First frequency spacing+K1*Second frequency spacing, where F1 is a reference frequency position of a frequency range to which the candidate frequency positions in the first set belong, L1 is an integer greater than or equal to 0, and K1 is an integer greater than or equal to 0. The frequency range may include an interval determined by a maximum frequency position and a minimum frequency position, and the frequency range may further include a boundary point or may not include a boundary point, for example, the maximum frequency position and/or the minimum frequency position. The reference frequency position may be any frequency position in the frequency range, for example, a start frequency position.

Optionally, the first frequency spacing is different from the second frequency spacing. For example, a size of the first frequency spacing is greater than a bandwidth of an SSB in the synchronization burst set, and a size of the second frequency spacing is greater than or equal to a bandwidth of an SSB in the synchronization burst set. The following uses an example in which M is 4. For example, the frequency range to which the candidate frequency positions in the first set belong is [3000 MHz, 24250 MHz], the reference frequency position is 3000 MHz (3000 MHz is a start frequency position in the frequency range), the first frequency spacing is 14.4 MHz, and the second frequency spacing is 3.6 MHz. In this case, the candidate frequency position in the first set satisfies the following formula: 3000 MHz+L1*14.4 MHz+K1*3.6 MHz, where L1=0, 1, 2, . . . , 1475, and K1=0, 1, . . . , 3. In this case, for four candidate frequency positions, refer to 4-1 in FIG. 4, which are respectively 3000 MHz, 3003.6 MHz, 3007.2 MHz, and 30010.8 MHz. For another example, the frequency range to which the candidate frequency positions in the first set belong is [24250 MHz, 100 GHz], the reference frequency position is 24250.08 MHz (24250.08 MH is greater than a start frequency position 24250 MHz in the frequency range), the first frequency spacing is 115.2 MHz, and the second frequency spacing is 28.8 MHz. In this case, the candidate frequency position in the first set satisfies the following formula: 24250.08 MHz+L1*115.2 MHz+K1*28.8 MHz, where L1=0, 1, 2, . . . , 2630, and K1=0, 1, . . . , 3. In this case, for four candidate frequency positions, refer to 4-2 in FIG. 4, which are respectively 24250.08 MHz, 24278.88 MHz, 24307.68 MHz, and 24336.48 MHz.

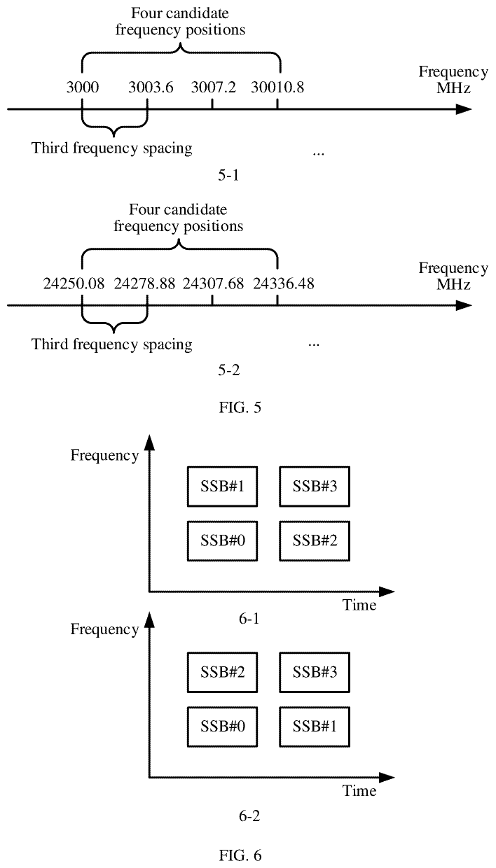

Optionally, a candidate frequency position in the second set satisfies the following formula: F2+L2*Third frequency spacing, where F2 is a reference frequency position of a frequency range to which the candidate frequency positions in the second set belong, and L2 is an integer greater than or equal to 0. Optionally, a size of the third frequency spacing is greater than or equal to a bandwidth of an SSB in the synchronization burst set. The following uses an example in which M is 4. For example, the frequency range to which the candidate frequency positions in the second set belong is [3000 MHz, 24250 MHz], the reference frequency position is 3000 MHz (3000 MHz is a start frequency position in the frequency range), and the third frequency spacing is 3.6 MHz. In this case, the candidate frequency position in the second set satisfies the following formula: 3000 MHz+L2*3.6 MHz, where L2=0, 1, 2, . . . , 5902. In this case, for four candidate frequency positions, refer to 5-1 in FIG. 5, which are respectively 3000 MHz, 3003.6 MHz, 3007.2 MHz, and 30010.8 MHz. For another example, the frequency range to which the candidate frequency positions in the second set belong is [24250 MHz, 100 GHz], the reference frequency position is 24250.08 MHz (24250.08 MH is greater than a start frequency position 24250 MHz in the frequency range), and the third frequency spacing is 28.8 MHz. In this case, the candidate frequency position in the second set satisfies the following formula: 24250.08 MHz+L2*28.8 MHZ, where L2=0, 1, 2, . . . , 2630. In this case, for four candidate frequency positions, refer to 5-2 in FIG. 5, which are respectively 24250.08 MHz, 24278.88 MHz, 24307.68 MHZ, and 24336.48 MHz.

2. A first candidate frequency position of the M candidate frequency positions is associated with one synchronization raster position. In other words, the first candidate frequency position is corresponding to one synchronization raster position. A correspondence (a correspondence between the first candidate frequency position and the synchronization raster position) is predefined or preconfigured. M-1 candidate frequency positions of the M candidate frequency positions other than the first candidate frequency position may be determined based on the first candidate frequency position and/or frequency spacing between adjacent candidate frequency positions of the M candidate frequency positions. In other words, when the M candidate frequency positions are associated with one synchronization raster position, the first candidate frequency position of the M candidate frequency positions is associated with one synchronization raster position, and the M-1 candidate frequency positions of the M candidate frequency positions other than the first candidate frequency position may be determined based on the first candidate frequency position and/or the frequency spacing between adjacent candidate frequency positions of the M candidate frequency positions.

Optionally, when M is an odd number, the first candidate frequency position is an [(M+1)/2]^{th} candidate frequency position (counting from 1) of the M candidate frequency positions; or when M is an even number, the first candidate frequency position is an (M/2)^{th} candidate frequency position or an (M/2+1)^{th} candidate frequency position (counting from 1) of the M candidate frequency positions. An intermediate SSB of a plurality of SSBs that can be multiplexed in a frequency division manner can be enabled to be located at a predefined frequency position, to help the terminal device adjust an operating frequency range of a radio frequency link of the terminal device when SSB search and detection are performed, thereby reducing complexity of the terminal device.

Optionally, the frequency spacing between adjacent candidate frequency positions of the M candidate frequency positions is predefined or preconfigured, or the frequency spacing between adjacent candidate frequency positions of the M candidate frequency positions is indicated by the network device to the terminal device. For example, the frequency spacing between adjacent candidate frequency positions of the M candidate frequency positions may be a bandwidth of an SSB in the synchronization burst set. For another example, the frequency spacing between adjacent candidate frequency positions of the M candidate frequency positions is related to a frequency band, and frequency spacing between adjacent candidate frequency positions of the M candidate frequency positions in different frequency bands may be different. For example, the SSB occupies 240 REs in frequency domain. For a frequency band 1, frequency spacing between adjacent candidate frequency positions of the M candidate frequency positions may be a bandwidth (3.6 MHz) of the SSB in the synchronization burst set at subcarrier spacing of 15 kHz. For a frequency band 2, frequency spacing between adjacent candidate frequency positions of the M candidate frequency positions may be a bandwidth (7.2 MHz) of the SSB in the synchronization burst set at subcarrier spacing of 30 kHz. The frequency spacing between adjacent candidate frequency positions of the M candidate frequency positions in the frequency band 1 may differ from the frequency spacing between adjacent candidate frequency positions of the M candidate frequency positions in the frequency band 2. Optionally, an RE of an SSB in the synchronization burst set may be located at one of the M candidate frequency positions. For example, that one of the M candidate frequency positions is used to transmit one SSB in the synchronization burst set may be an RE of the SSB in the synchronization burst set may be located at one of the M candidate frequency positions. The RE may be a central RE of the SSB in the synchronization burst set, a 1^{st} RE of the SSB, a last RE of the SSB, any RE of the SSB, or the like. This is not limited herein. For example, the SSB in the synchronization burst set occupies 240 REs in frequency domain, the central RE is the 120th RE (counting from 0), the 1^{st} RE is the Oth RE, and the last RE may be the 239^{th} RE.

The 120th RE, the Oth RE, or the 239^{th} RE may be located at one of the M candidate frequency positions. For another example, when M is an even number, the RE may be a last RE of an (M/ 2)^{th} SSB or a 1^{st} RE (counting from 1) of an (M/2+1)^{th} SSB. For another example, when M is an odd number, the RE may be a central RE (counting from 1) of an (M+1)^{th} SSB. Frequency centers of a plurality of SSBs that can be multiplexed in a frequency division manner can be enabled to be located at a predefined frequency position, to help the terminal device adjust an operating frequency range of a radio frequency link of the terminal device when SSB search and detection are performed, thereby reducing complexity of the terminal device.

Optionally, a maximum quantity of frequency division-based SSBs in the synchronization burst set is a predefined or preconfigured value, for example, 2, 4, 8, 16, 32, or 64. In a possible embodiment, the maximum quantity of frequency division-based SSBs in the synchronization burst set may be determined based on a frequency range to which the M candidate frequency positions belong. In other words, the maximum quantity of frequency division-based SSBs in the synchronization burst set may be determined based on a frequency range of a cell to which the SSBs belong. For example, the frequency range to which the M candidate frequency positions belong is less than or equal to 3 gigahertz (GHz), and the maximum quantity of frequency division-based SSBs in the synchronization burst set is 4; the frequency range to which the M candidate frequency positions belong is greater than 3 GHZ and less than or equal to 6 GHZ, and the maximum quantity of frequency division-based SSBs in the synchronization burst set is 8; and the frequency range to which the M candidate frequency positions belong is greater than 6 GHz, and the maximum quantity of frequency division-based SSBs in the synchronization burst set is 8, 16, 32, or 64.

Optionally, step 303 may be as follows: The network device sends, in the at least two candidate frequency positions and at least two candidate time-domain positions, the at least two SSBs to the terminal device. In other words, a plurality of SSBs in the synchronization burst set may be transmitted in both frequency division multiplexing and time division multiplexing manners. For example, the synchronization burst set includes four SSBs, a maximum of two frequency division-based SSBs are supported in frequency domain, and a maximum of two time-divided SSBs are supported in time domain. In a possible embodiment, the SSBs in the synchronization burst set are consecutively mapped to a pattern of candidate time-frequency positions of the SSBs in the synchronization burst set firstly in ascending order of indexes of frequency-domain units and then in ascending order of indexes of time units. For example, the synchronization burst set includes four SSBs, a maximum of two frequency division-based SSBs are supported in frequency domain, and a maximum of two time-divided SSBs are supported in time domain. Candidate time-frequency positions of the four SSBs are shown in FIG. 6-1.

In another possible embodiment, the SSBs in the synchronization burst set are consecutively mapped to a pattern of candidate time-frequency positions of the SSBs in the synchronization burst set firstly in ascending order of indexes of time units and then in ascending order of indexes of frequency-domain units. For example, the synchronization burst set includes four SSBs, a maximum of two frequency division-based SSBs are supported in frequency domain, and a maximum of two time-divided SSBs are supported in time domain. Candidate time-frequency positions of the four SSBs are shown in FIG. 6-2.

The candidate time-frequency position may include a candidate frequency position and a candidate time-domain position. For the candidate frequency positions herein, reference may be made to the M candidate frequency positions. The candidate time-domain position herein may be in a half-frame of a system frame, in other words, the candidate time-domain position is determined through the system frame, the half-frame, and a position in the half-frame. An absolute time length of the system frame is 10 ms, and may be divided, by using 5 ms as half-frame time, into two half-frames a former half-frame and a latter half-frame.

Optionally, at least one of the system frame, the half-frame, or the position in the half-frame may be predefined or preconfigured. In a possible embodiment, the system frame and the half-frame may be indicated by the network device to the terminal device, for example, indicated to the terminal device through a PBCH. The position in the half-frame is predefined, preconfigured, or indicated by the network device to the terminal device, for example, indicated to the terminal device through the PBCH. For example, when subcarrier spacing of the SSBs in the synchronization burst set is 120 kHz, the position in the half-frame may be one of the following positions: {4, 8, 16, 20}+28·n, where n=0, 1, 2, 3, 5, 6, 7, 8, 10, 11, 12, 13, 15, 16, 17, 18.

The ascending order of indexes may be an increasing order of indexes. For example, one slot includes 14 symbols, and the 14 symbols are arranged in ascending order or increasing order of indexes. Optionally, the ascending order of indexes of time units may be arranging the indexes of time units from front to back. For example, one slot includes 14 symbols, a symbol whose index is 0 is located before a symbol whose index is 1, and the symbol whose index is 1 is located before a symbol whose index is 2. The same applies to the rest. Optionally, the ascending order or increasing order of the indexes of the frequency-domain units may be an ascending order of candidate frequency-domain positions.

Optionally, the pattern of the candidate time-frequency positions of the SSBs in the synchronization burst set is predefined or preconfigured, or the pattern of the candidate time-frequency positions of the SSBs in the synchronization burst set is indicated by the network device to the terminal device. Optionally, the pattern of the candidate time-frequency positions of the SSBs in the synchronization burst set may belong to a first pattern, and the first pattern is a predefined or preconfigured candidate time-frequency position of the SSBs. A quantity of SSBs supported by the first pattern may be greater than or equal to a quantity of SSBs in the synchronization burst set. In other words, the quantity of SSBs supported by the first pattern may be greater than or equal to a maximum quantity of SSBs supported by a cell covered by the network device. When the quantity of SSBs supported by the first pattern is greater than the maximum quantity of SSBs supported by the cell covered by the network device, there may be the following implementations. Details are as follows.

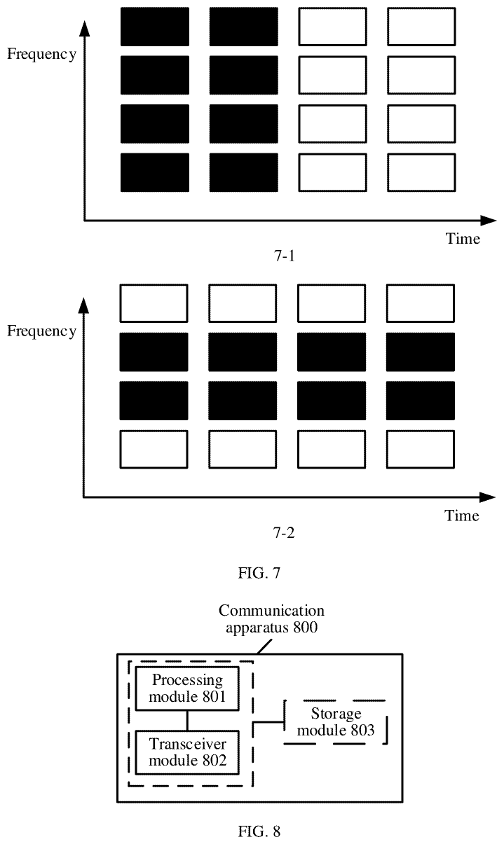

1. The network device may consecutively select, in the first pattern, firstly in ascending order of indexes of frequency-domain units and then in ascending order of indexes of time units, one or more candidate time-frequency positions as the candidate time-frequency positions of the SSBs in the synchronization burst set. For example, the first pattern includes 16 candidate time-frequency positions, the maximum quantity of SSBs supported by the cell covered by the network device is 8, and the network device may select eight candidate time-frequency positions from the 16 candidate time-frequency positions, to send the SSBs in the synchronization burst set. As shown in 7-1 in FIG. 7, the 8 candidate time-frequency positions are the 1^{st} column and the 2nd column from left to right, parts filled with black in 7-1 in FIG. 7.

2. The network device may randomly select one or more candidate time-frequency positions from the first pattern as the candidate time-frequency positions of SSBs in the synchronization burst set. For example, the first pattern includes 16 candidate time-frequency positions, the maximum quantity of SSBs supported by the cell covered by the network device is 8, and the network device may select eight candidate time-frequency positions from the 16 candidate time-frequency positions, to send the SSBs in the synchronization burst set. As shown in 7-2 in FIG. 7, the eight candidate time-frequency positions are the 2^{nd} row and the 3^{rd} row from top to bottom, parts filled with black in 7-2 in FIG. 7.

Optionally, a period of an SSB in the synchronization burst set may be the same as or different from a period of the synchronization burst set. For example, when the period of the SSB in the synchronization burst set is the same as the period of the synchronization burst set, the period of the SSB in the synchronization burst set and the period of the synchronization burst set are less than 5 milliseconds. For another example, when the period of the SSB in the synchronization burst set is different from the period of the synchronization burst set, the period of the synchronization burst set is greater than or equal to 5 milliseconds, and the period of the SSB in the synchronization burst set is less than 5 milliseconds.

The period of the synchronization burst set refers to a period in which all SSBs in the synchronization burst set are repeatedly sent.

In the foregoing embodiment, as some or all SSBs in the synchronization burst set are transmitted in a frequency division multiplexing manner, time taken by the terminal device for SSB search can be reduced, so that the terminal device can perform synchronization based on a found SSB more quickly and initiate random access, and therefore, an access latency of the terminal device can be reduced. In addition, the network device may complete sending the SSBs in the synchronization burst set in shorter time. In this way, the network device can be shut down in shorter time as required, so that energy consumption of the network device can be reduced, thereby facilitating energy saving of the network device.

The foregoing describes the embodiments from a perspective of interaction between the devices. To implement the foregoing functions, each device includes a corresponding hardware structure and/or software module for performing each function. A person skilled in the art should easily be aware that, in combination with units and algorithm steps of the examples described herein, the embodiments may be implemented by hardware or a combination of hardware and computer software. Whether a function is performed by hardware or hardware driven by computer software depends on particular applications. A person skilled in the art may use different methods to implement the described functions for each particular application, but it should not be considered that the implementation goes beyond the scope of the embodiments.

In the embodiments, the terminal device or the network device may be divided into functional modules based on the foregoing method examples. For example, each functional module may be obtained through division based on a corresponding function, or two or more functions may be integrated into one processing module. The integrated module may be implemented in a form of hardware, or may be implemented in a form of a software functional module. In the embodiments, module division is an example, and is merely a logical function division. In actual implementation, another division manner may be used.

FIG. 8 is a diagram of a structure of a communication apparatus according to an embodiment. The communication apparatus 800 may be used in the method shown in the embodiment in FIG. 3. As shown in FIG. 8, the communication apparatus 800 includes a processing module 801 and a transceiver module 802. The processing module 801 may be one or more processors, and the transceiver module 802 may be a transceiver or a communication interface. The communication apparatus may be configured to implement a function of the terminal device or the network device in any one of the foregoing method embodiments, or configured to implement a function of a network element in any one of the foregoing method embodiments. The network element or network function may be a network element in a hardware device, a software function running on dedicated hardware, or a virtualized function instantiated on a platform (for example, a cloud platform). Optionally, the communication apparatus 800 may further include a storage module 803, configured to store program code and data that are of the communication apparatus 800.

In an instance, the communication apparatus is used as a terminal device or a chip used in the terminal device, and performs the steps (or operations) performed by the terminal device in the foregoing method embodiments. The transceiver module 802 is configured to perform a sending action and/or a receiving action performed by the terminal device in the embodiment in FIG. 3, for example, support the terminal device in performing another process of the technology described herein. The processing module 801 may be configured to support the communication apparatus 800 in performing a processing action in the foregoing method embodiments, for example, support the terminal device in performing another process of the technology described herein.

For example, the processing module 801 is configured to determine M candidate frequency positions, where one of the M candidate frequency positions is used to transmit one synchronization signal block SSB in a synchronization burst set, the synchronization burst set includes N SSBs, and both M and N are integers greater than or equal to 2. The transceiver module 802 is configured to receive, based on at least two candidate frequency positions of the M candidate frequency positions, at least two SSBs of the N SSBs from the network device, and the at least two SSBs are associated with different index values.

Optionally, when receiving, based on the at least two candidate frequency positions of the M candidate frequency positions, the at least two SSBs of the N SSBs from the network device, the processing module 801 is configured to receive, based on the at least two candidate frequency positions and at least two candidate time-domain positions, the at least two SSBs from the network device.

In another instance, the communication apparatus is used as a network device or a chip used in the network device, and performs the steps (or operations) performed by the network device in the foregoing method embodiments. The transceiver module 802 is configured to perform a sending action and/or a receiving action performed by the network device in the embodiment in FIG. 3, for example, support the network device in performing another process of the technology described herein. The processing module 801 may be configured to support the communication apparatus 800 in performing a processing action in the foregoing method embodiments, for example, support the network device in performing another process of the technology described herein.

For example, the processing module 801 is configured to determine M candidate frequency positions, where one of the M candidate frequency positions is used to transmit one synchronization signal block SSB in a synchronization burst set, the synchronization burst set includes N SSBs, and both M and N are integers greater than or equal to 2. The transceiver module 802 is configured to send, in at least two candidate frequency positions of the M candidate frequency positions, at least two SSBs of the N SSBs to the terminal device, and the at least two SSBs are associated with different index values.

Optionally, when sending, in the at least two candidate frequency positions of the M candidate frequency positions, the at least two SSBs of the N SSBs to the terminal device, the transceiver module 802 is configured to send, in the at least two candidate frequency positions and at least two candidate time-domain positions, the at least two SSBs to the terminal device.

In a possible embodiment, when the terminal device or the network device is a chip, the transceiver module 802 may be a communication interface, a pin, a circuit, or the like. The communication interface may be configured to input to-be-processed data to a processor, and may output a processing result of the processor to the outside. During specific implementation, the communication interface may be a general-purpose input/output (GPIO) interface, and may be connected to a plurality of peripheral devices (for example, a display (LCD), a camera, a radio frequency (RF) module, and an antenna). The communication interface is connected to the processor through a bus.

The processing module 801 may be a processor. The processor may execute computer-executable instructions stored in the storage module, so that the chip performs the method in the embodiment of FIG. 3. Further, the processor may include a controller, an arithmetic logic unit, and a register. For example, the controller may be responsible for instruction decoding, and sending a control signal for an operation corresponding to the instructions. The arithmetic logic unit may be responsible for performing a fixed-point or floating-point arithmetic operation, a shift operation, a logic operation, and the like, and may also perform an address operation and address translation. The register may be responsible for saving a quantity of register operations, intermediate operation results, and the like that are temporarily stored during instruction execution. During specific implementation, a hardware architecture of the processor may be an ASIC architecture, a microprocessor without interlocked piped stages architecture (MIPS), an advanced reduced instruction set computer machine (ARM) architecture, a second processor (NP) architecture, or the like. The processor may be a single-core processor or a multi-core processor. The storage module may be a storage module inside the chip, for example, a register or a cache. Alternatively, the storage module may also be a storage module outside the chip, for example, a ROM, another type of static storage device that can store static information and instructions, or a RAM.

Functions respectively corresponding to the processor and the interface may be implemented through hardware, or may be implemented through software, or may be implemented through a combination of software and hardware. This is not limited herein.

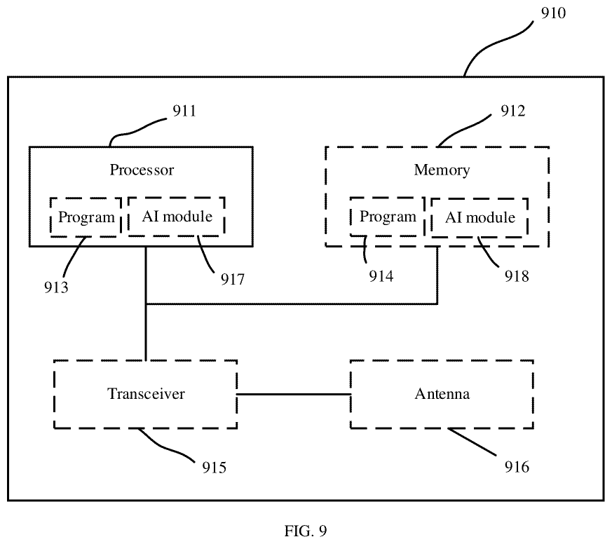

FIG. 9 is a diagram of a structure of another communication apparatus according to an embodiment. The communication apparatus 910 may include a module, a unit, an element, a circuit, or an interface, which are appropriately configured together to perform the solution. The communication apparatus 910 may be the foregoing terminal device or network device, or may be a component (for example, a chip) in these devices, to implement the methods described in the foregoing method embodiments. The communication apparatus 910 includes one or more processors 911. The processor 911 may be a general-purpose processor, a dedicated processor, or the like. For example, the processor may be a baseband processor or a central processing unit. The baseband processor may be configured to process a communication protocol and communication data. The central processing unit may be configured to control the communication apparatus (for example, the terminal device, the network device, or the chip), to execute a software program and process data of the software program.

Optionally, the processor 911 may include a program 913 (which may also be referred to as code or instructions sometimes), and the program 913 may be run on the processor 911, so that the communication apparatus 910 performs the methods described in the foregoing embodiments. The communication apparatus 910 may include a circuit (not shown in FIG. 9), and the circuit is configured to implement a function of the terminal device, the network device, or the like in the foregoing embodiments. Optionally, the communication apparatus 910 may include one or more memories 912 storing a program 914 (which may also be referred to as code or instructions sometimes), and the program 914 may be run on the processor 911, so that the communication apparatus 910 performs the methods described in the foregoing method embodiments.

Optionally, the processor 911 and/or the memory 912 may include an AI module 917 and an AI module 918, and the AI module is configured to implement an AI-related function. The AI module may be implemented through software, hardware, or a combination of the software and the hardware. For example, the AI module may include an RIC module. For example, the AI module may be a near-real-time RIC or a non-real-time RIC. Optionally, the processor 911 and/or the memory 912 may further store data. The processor and the memory may be separately disposed, or may be integrated together.

Optionally, the communication apparatus 910 may further include a transceiver 915 and/or an antenna 916. The processor 911 may also be referred to as a processing unit sometimes, and controls the communication apparatus (for example, the terminal device or the network device). The transceiver 915 may also be referred to as a transceiver unit, a transceiver machine, a transceiver circuit, a transceiver, or the like sometimes, and is configured to implement receiving and sending functions of the communication apparatus through the antenna 916.

An embodiment further provides a communication apparatus. The communication apparatus includes at least one processor and a memory. The memory is configured to store a computer program or instructions. The at least one processor is configured to execute the computer program or the instructions in the memory, to perform the method in any one of the implementations in the embodiment of FIG. 3.

An embodiment further provides a non-transitory computer-readable storage medium. The non-transitory computer-readable storage medium stores computer instructions. When the computer instructions are executed, a computer is enabled to perform the method in any one of the implementations in the embodiment of FIG. 3.

An embodiment further provides a computer program product. The computer program product includes computer program code. When the computer program code is run by a computer, the computer is enabled to perform the method in any one of the implementations in the embodiment of FIG. 3.

An embodiment further provides a chip. The chip includes at least one processor and an interface. The processor is configured to read and execute instructions stored in a memory. When the instructions are run, the chip is enabled to perform the method in any one of the implementations in the embodiment of FIG. 3.

The foregoing units described as separate parts may or may not be physically separate, and parts displayed as units may or may not be physical units, may be located in one position, or may be distributed on a plurality of network units. Some or all of the units may be selected based on an actual requirement, to achieve the objectives of the embodiments. In addition, network element units in the embodiments may be integrated into one processing unit, each of the units may exist alone physically, or two or more units are integrated into one unit. The foregoing integrated unit may be implemented in a form of hardware, or may be implemented in a form of a software network element unit.

When the foregoing integrated unit is implemented in the form of the software network element unit and sold or used as an independent product, the integrated unit may be stored in a non-transitory computer-readable storage medium. Based on such an understanding, the embodiments may be embodied in a form of a software product. The computer software product is stored in a storage medium and includes several instructions for instructing a computer device (which may be a personal computer, a terminal device, a cloud server, a network device, or the like) to perform all or some of the steps (or operations) of the method in the embodiments. The foregoing storage medium includes any medium that can store program code, for example, a USB flash drive, a removable hard disk, a read-only memory (ROM), a random access memory (RAM), a magnetic disk, or an optical disc. The foregoing descriptions are merely embodiments, but are not intended as limiting. Any modification or replacement readily figured out by a person skilled in the art within shall fall within the scope of the embodiments.

1. A method comprising:
determining M candidate frequency positions, wherein one of the M candidate frequency positions is used to transmit one synchronization signal block SSB in a synchronization burst set, the synchronization burst set comprises N SSBs, and both M and N are integers greater than or equal to 2; and
receiving, based on at least two candidate frequency positions of the M candidate frequency positions, at least two SSBs of the N SSBs from a network device, wherein the at least two SSBs are associated with different index values.

2. The method according to claim 1, wherein
the M candidate frequency positions are associated with M synchronization raster positions; or
the M candidate frequency positions are associated with one synchronization raster position.

3. The method according to claim 2, wherein a first candidate frequency position of the M candidate frequency positions is associated with one synchronization raster position; and
M-1 candidate frequency positions of the M candidate frequency positions other than the first candidate frequency position are determined based on the first candidate frequency position and/or frequency spacing between adjacent candidate frequency positions of the M candidate frequency positions, wherein
the frequency spacing between adjacent candidate frequency positions of the M candidate the frequency spacing between adjacent candidate frequency positions of the M candidate frequency positions is indicated by the network device to a terminal device.

4. The method according to claim 3, wherein
when M is an odd number, the first candidate frequency position is an [(M+1)/2]^{th} candidate frequency position of the M candidate frequency positions; and
when M is an even number, the first candidate frequency position is an (M/2)^{th} candidate frequency position or an (M/2+1)^{th} candidate frequency position of the M candidate frequency positions.

5. The method according to claim 1, wherein the M candidate frequency positions belong to a first set, and a candidate frequency position in the first set satisfies the following formula:
$$F 1 + L 1 * First frequency spacing + K 1 * Second frequency spacing ,$$
wherein F1 is a reference frequency position of a frequency range to which the candidate frequency positions in the first set belong, L1 is an integer greater than or equal to 0, K1 is an integer greater than or equal to 0, and the first frequency spacing is different from the second frequency spacing.

6. The method according to claim 1, wherein the M candidate frequency positions belong to a second set, and a candidate frequency position in the second set satisfies the following formula:
$$F 2 + L 2 * Third frequency spacing ,$$
wherein F2 is a reference frequency position of a frequency range to which the candidate frequency positions in the second set belong, and L2 is an integer greater than or equal to 0.

7. The method according to claim 1, wherein
the SSBs in the synchronization burst set are consecutively mapped to a pattern of candidate time-frequency positions of the SSBs in the synchronization burst set firstly in ascending order of indexes of frequency-domain units and then in ascending order of indexes of time units; or
the SSBs in the synchronization burst set are consecutively mapped to a pattern of candidate time-frequency positions of the SSBs in the synchronization burst set firstly in ascending order of indexes of time units and then in ascending order of indexes of frequency-domain units; and
the pattern of the candidate time-frequency positions of the SSBs in the synchronization burst set is predefined or preconfigured, or the pattern of the candidate time-frequency positions of the SSBs in the synchronization burst set is indicated by the network device to the terminal device.

8. A method comprising:
determining M candidate frequency positions, wherein one of the M candidate frequency positions is used to transmit one synchronization signal block SSB in a synchronization burst set, the synchronization burst set comprises N SSBs, and both M and N are integers greater than or equal to 2; and
sending, in at least two candidate frequency positions of the M candidate frequency positions, at least two SSBs of the N SSBs to a terminal device, wherein the at least two SSBs are associated with different index values.

9. The method according to claim 8, wherein
the M candidate frequency positions are associated with M synchronization raster positions; or
the M candidate frequency positions are associated with one synchronization raster position.

10. The method according to claim 9, wherein a first candidate frequency position of the M candidate frequency positions is associated with one synchronization raster position; and
M-1 candidate frequency positions of the M candidate frequency positions other than the first candidate frequency position are determined based on the first candidate frequency position and/or frequency spacing between adjacent candidate frequency positions of the M candidate frequency positions, wherein
the frequency spacing between adjacent candidate frequency positions of the M candidate frequency positions is predefined, or
the frequency spacing between adjacent candidate frequency positions of the M candidate frequency positions is indicated by a network device to the terminal device.

11. The method according to claim 10, wherein when M is an odd number, the first candidate frequency position is an [(M+1)/2]^{th} candidate frequency position of the M candidate frequency positions; and
when M is an even number, the first candidate frequency position is an (M/2)^{th} candidate frequency position or an (M/2+1)^{th} candidate frequency position of the M candidate frequency positions.

12. The method according to claim 8, wherein the M candidate frequency positions belong to a first set, and a candidate frequency position in the first set satisfies the following formula:
$$F 1 + L 1 * First frequency spacing + K 1 * Second frequency spacing ,$$
wherein F1 is a reference frequency position of a frequency range to which the candidate frequency positions in the first set belong, L1 is an integer greater than or equal to 0, K1 is an integer greater than or equal to 0, and the first frequency spacing is different from the second frequency spacing.

13. The method according to claim 8, wherein the M candidate frequency positions belong to a second set, and a candidate frequency position in the second set satisfies the following formula:
$$F 2 + L 2 * Third frequency spacing ,$$
wherein F2 is a reference frequency position of a frequency range to which the candidate frequency positions in the second set belong, and L2 is an integer greater than or equal to 0.

14. The method according to claim 8, wherein
the SSBs in the synchronization burst set are consecutively mapped to a pattern of candidate time-frequency positions of the SSBs in the synchronization burst set firstly in ascending order of indexes of frequency-domain units and then in ascending order of indexes of time units; or
the SSBs in the synchronization burst set are consecutively mapped to a pattern of candidate time-frequency positions of the SSBs in the synchronization burst set firstly in ascending order of indexes of time units and then in ascending order of indexes of frequency-domain units; and
the pattern of the candidate time-frequency positions of the SSBs in the synchronization burst set is predefined or preconfigured, or the pattern of the candidate time-frequency positions of the SSBs in the synchronization burst set is indicated by the network device to the terminal device.

15. An apparatus, comprising:
at least one processor; and
a memory storing programming instructions for execution by the at least one processor, the programming instructions instructing the communication apparatus to perform operations comprising:
determining M candidate frequency positions, wherein one of the M candidate frequency positions is used to transmit one synchronization signal block SSB in a synchronization burst set, the synchronization burst set comprises N SSBs, and both M and N are integers greater than or equal to 2; and
receiving, based on at least two candidate frequency positions of the M candidate frequency positions, at least two SSBs of the N SSBs from a network device, wherein the at least two SSBs are associated with different index values.

16. The apparatus according to claim 15, wherein
the M candidate frequency positions are associated with M synchronization raster positions; or
the M candidate frequency positions are associated with one synchronization raster position.

17. The apparatus according to claim 16, wherein a first candidate frequency position of the M candidate frequency positions is associated with one synchronization raster position; and
M-1 candidate frequency positions of the M candidate frequency positions other than the first candidate frequency position are determined based on the first candidate frequency position and/or frequency spacing between adjacent candidate frequency positions of the M candidate frequency positions, wherein
the frequency spacing between adjacent candidate frequency positions of the M candidate frequency positions is predefined, or
the frequency spacing between adjacent candidate frequency positions of the M candidate frequency positions is indicated by the network device to a terminal device.

18. The apparatus according to claim 17, wherein
when M is an odd number, the first candidate frequency position is an [(M+1)/2]^{th} candidate frequency position of the M candidate frequency positions; and
when M is an even number, the first candidate frequency position is an (M/2)^{th} candidate frequency position or an (M/2+1)^{th} candidate frequency position of the M candidate frequency positions.

19. The apparatus according to claim 15, wherein the M candidate frequency positions belong to a first set, and a candidate frequency position in the first set satisfies the following formula:
$$F 1 + L 1 * First frequency spacing + K 1 * Second frequency spacing ,$$
wherein F1 is a reference frequency position of a frequency range to which the candidate frequency positions in the first set belong, L1 is an integer greater than or equal to 0, K1 is an integer greater than or equal to 0, and the first frequency spacing is different from the second frequency spacing.

20. The apparatus according to claim 15, wherein the M candidate frequency positions belong to a second set, and a candidate frequency position in the second set satisfies the following formula:
$$F 2 + L 2 * Third frequency spacing ,$$
wherein F2 is a reference frequency position of a frequency range to which the candidate frequency positions in the second set belong, and L2 is an integer greater than or equal to 0.
